(19) United States
(12) Patent Application Publication
(10) Pub. No.: US 2006/0172273 A1
(43) Pub. Date: Aug. 3, 2006

(54) Method and apparatus for identifying a page of a plurality of pages, and relaying the identity of the page to a computer

(76) Inventors: Edmond Joseph Heffernan, Cork (IE); Heith Fensom, Hertfordshire (GB)

Correspondence Address: SUGHRUE MION, PLLC, 2100 PENNSYLVANIA AVENUE, N.W., SUITE 800, WASHINGTON, DC, 20037, US

(21) Appl. No.: 10/548,644

(22) PCT Filed: Mar. 15, 2004
(86) PCT No.: PCT/IE04/00036

§ 371 Date: Apr. 7, 2006

(30) Foreign Application Priority Data
Mar. 14, 2003 (IE) S2003/0194

(51) Int. Cl. G09B 5/00

(52) U.S. Cl. 434/315

(57) ABSTRACT

A manual (1) comprising a binder (6) and pages (3) releasably retained in the binder (6) comprises apparatus (2) for identifying an opened page (3) and for transmitting the identity of the page (3) to a computer (4). The apparatus (2) comprises a carrier member (15) which carries a plurality of photo sensors (16) for reading a binary identity code (17) along an edge of each page (3) for identifying the page. A plurality of input keys (37) on the carrier member (15) carry identifying symbols (40) which correspond to identifying symbols (41) provided on the pages (3) adjacent passages of text for facilitating inputting of select signals for operating the computer (4) to display additional data on a visual display unit (5) relating to the passage identified by the corresponding identifying symbol. A microprocessor in the carrier member (15) reads signals from the photo sensors (16) and the input keys (37) for identifying an open page (3) of the manual (1) and for identifying the passage for which additional data is to be displayed on the visual display unit (5). The microprocessor transmits a signal through a radio transmitter in the carrier member (15) to a radio receiver (35) of the computer (4), and the computer (4) is operated to display the additional data. The additional data which corresponds to the manual (1) is typically provided on a CD-ROM and is read into and stored in the computer (4). The apparatus (2) permits ready display of additional data relating to subject matter of a passage of text in the manual (1).

The present invention relates to a method and apparatus for identifying a page of a plurality of pages and for relaying the identity of the page to a computer, and the invention also relates to a combination of the apparatus and a computer for operating the computer to display data relating to subject matter in a passage of text on a page of the plurality of pages. The invention also relates to a manual comprising the apparatus.

Data, for example, training data, instruction data, and any other data on any subject, machine, process or the like, may be provided in hard copy form, for example, in the form of a manual having a plurality of pages on which relevant data is printed, or the manuals may be provided in soft form, for example, on a CD-ROM for reading into a computer for in turn displaying on a visual display screen. Both methods of providing data have advantages and disadvantages. Some people tend to be intimidated by computers, and thus prefer to have a hard copy form of the manual, while others prefer the convenience of a computer. Indeed, there are advantages in providing manuals in soft form, in that the amount of data which can be made available more conveniently is significantly greater in soft form than in hard copy form, and additionally the data in soft form may be provided in an animated form which is impossible in a hard copy manual. A better arrangement would be to provide some of the material in hard copy form, and more detailed explanations, accompanied by, for example, animation on CD-ROM using computer graphics. However, a disadvantage of this arrangement is the difficulty of transferring readily easily from one medium, namely, the hard copy medium, to the other, namely, the soft copy medium. For example, if one were referred from a page in a hard copy manual to a more detailed reference in soft copy, in general, one would be required to key in data to the computer relating to the relevant page or the relevant reference of the data in order to display the additional data stored in soft form on a visual display screen. Even with the use of a mouse, calling up specific data can be slow and tedious. However, the requirement to enter data to a computer through a. keyboard or a mouse, in many cases is intimidating to those who are not computer literate.

There is therefore a need for a method and apparatus for providing a manual in hard copy form and in soft copy form, which overcomes these problems.

The present invention is directed towards providing such a method and apparatus, and in particular, the invention is directed towards providing a method and apparatus for identifying a page of a plurality of pages and for relaying the identity of the page to a computer. The invention is also directed towards a manual comprising the apparatus, and to a combination of the apparatus and a computer for operating the computer to display data relating to subject matter in a passage of text on a page of the plurality of pages.

According to the invention there is provided apparatus for identifying a page of a plurality of pages and for relaying the identify of the page to a computer, wherein the apparatus comprises a carrier means, a reading means carried on the carrier means for reading an identity code on a page, and a communicating means for communicating the identity of the page to the computer.

In one embodiment of the invention the communicating means is carried on the carrier means.

In another embodiment of the invention the apparatus comprises a binder, in which the pages are retained, and the carrier means is operably mounted on the binder for co-operating with the pages for facilitating sequential reading of the identity codes on respective ones of the pages. Preferably, the binder comprises a front cover and a rear cover.

In one embodiment of the invention the carrier means is located on an inner surface of one of the front and rear covers. Preferably, the carrier means is located on the rear cover. Advantageously, the carrier means is located adjacent a side edge of the page opposite to a side edge of the page adjacent which the page is secured in the binder. Ideally, the carrier means is moveably connected to the binder, and is moveable between a reading position overlaying a portion of a page adjacent an edge thereof for reading the identity code thereon and an inoperative position clear of the page for facilitating turning of the pages in the binder.

In one embodiment of the invention the carrier means is swivelably connected to the binder. Preferably, the carrier means is swivelably connected to the binder by a pair of spaced apart carrier ring connectors.

In another embodiment of the invention each carrier ring connector comprises an upstanding limb extending substantially perpendicularly from the binder adjacent the page, so that the carrier means co-operates with each page with the reading means aligned with the identity code for reading thereof.

In a further embodiment of the invention the binder is a ring binder having a pair of spaced apart page engaging rings, each page engaging ring comprising an upstanding limb extending perpendicularly to the binder for locating the pages relative to the upstanding limb of the carrier ring connector with the distance of the identity codes from the upstanding limbs of the carrier ring connectors substantially constant.

In another embodiment of the invention each identity code is located on a portion of the corresponding page for co-operating with the reading means for reading thereof. Preferably, each identity code is a machine readable code. Advantageously, each identity code is printed on the corresponding page.

In one embodiment of the invention each identity code is a binary code comprising a plurality of discrete locations which are provided in one of two states for indicating a corresponding one of a binary one state and a binary zero state. Preferably, each identity code comprises ten discrete locations. Advantageously, the discrete locations forming the identity code on each page are aligned longitudinally along the page.

In one embodiment of the invention the reading means comprises at least one photo sensor for reading the identity code. Preferably, a plurality of photo sensors are provided, one photo sensor being provided corresponding to each discrete location of the identity code. Advantageously, each photo sensor comprises a light emitter and a light detector for detecting the presence or absence of light reflected by the corresponding discrete location from the light emitter. Ideally, the respective photo sensors are longitudinally aligned along the carrier means and are located thereon at spaced apart locations.

In another embodiment of the invention an input means is provided for facilitating inputting of a select signal for communicating to the computer for operating the computer to display data in response to the select signal. Preferably, the select signal for operating the computer to display data, operates the computer for displaying data relating to a feature on one of the pages.

In another embodiment of the invention an identifying symbol is provided for identifying a feature on a page for which data may be displayed by the computer. Preferably, a plurality of identifying symbols for identifying respective features are provided. Advantageously, appropriate ones of the identifying symbols are located on the page. Preferably, the appropriate ones of the identifying symbols are located on the page adjacent the corresponding feature. Ideally, the appropriate identifying symbols are printed on the page.

In one embodiment of the invention the feature identified by the identifying symbol is a passage of text on a page.

In one embodiment of the invention the input means is carried on the carrier means.

In another embodiment of the invention the input means comprises a plurality of input keys.

Preferably, the respective input keys correspond to respective ones of the corresponding identifying symbols, and the input keys are identified by respective corresponding ones of the identifying symbols.

In one embodiment of the invention some of the identifying symbols identifying the input keys are similar to those associated with keys of a mobile phone.

In another embodiment of the invention some of the input keys are provided for inputting select signals for controlling operation of the computer.

Preferably, the input keys are spaced apart from each other, and advantageously, the input keys are aligned longitudinally along the carrier means.

In one embodiment of the invention sixteen input keys are provided.

Alternatively, the input means comprises a longitudinally extending touch sensitive strip. Preferably, the touch sensitive strip outputs an analogue signal indicative of the location at which the touch sensitive strip is touched.

In one embodiment of the invention the carrier means comprises an elongated carrier member extending parallel to the adjacent edge of the adjacent page.

In another embodiment of the invention a microprocessor is located on the carrier means for receiving signals from the reading means and the input means for converting the signals into digital signals for communicating to the computer.

In a further embodiment of the invention the communicating means comprises a radio transmitter for transmitting signals to the computer.

In a still further embodiment of the invention the communicating means comprises a transceiver for transmitting and receiving signals to and from the computer.

In one embodiment of the invention a means is provided for detecting movement of the carrier means and for facilitating communication of a signal to the computer indicating that the carrier means is being moved for readying the computer to display data in the event of the inputting of a select signal through the input means.

The invention also provides a hard copy manual comprising a binder, a plurality of pages secured in the binder, at least some of the pages carrying an identity code for identification thereof, a carrier means located on the binder, a reading means carried on the carrier means for reading an identity code on a page of the hard copy manual, and a communicating means for communicating the identity of the page to a computer.

In one embodiment of the invention at least some of the pages have at least one identifying symbol for identifying a feature thereon, and an input means is provided for inputting a select signal corresponding to the identifying symbol for communicating to the computer for operating the computer to display data relating to the subject matter of the feature corresponding to the identifying symbol.

The invention further provides in combination apparatus according to the invention and a computer, wherein the apparatus communicates with the computer through the communicating means for indicating the identity of a page, and data relating to subject matter of the page is stored in or is accessible through the computer, and is selectable for display in response to a select signal communicated from the apparatus to the computer.

In one embodiment of the invention the computer is responsive to the select signal from the input means corresponding to one of the identifying symbols for displaying data relating to subject matter of a feature identified by the identifying symbol.

In another embodiment of the invention the computer is programmed to obtain the data to be displayed in response to the select signal from an external source over an external communications link.

In another embodiment of the invention the computer is programmed to obtain the data to be displayed over the internet.

In a further embodiment of the invention the computer is programmed for facilitating online transactions via an external communications link in response to signals inputted through the input means.

In a still further embodiment of the invention the computer is programmed for facilitating the making of a purchase over the internet.

In one embodiment of the invention a radio receiver is provided associated with the computer for receiving signals transmitted by the transmitter of the apparatus and for relaying the received signals to the computer.

In an alternative embodiment of the invention a transceiver is provided associated with the computer for receiving signals transmitted by the transmitter of the apparatus, and for transmitting signals to a corresponding transceiver of the apparatus.

Further the invention provides a method for communicating the identity of a page of a plurality of pages to a computer, the method comprising the steps of reading an identity code on the page indicative of the identity of the page, and communicating the identity of the page to the computer through a communicating means.

In one embodiment of the invention the method comprises the further step of inputting a select signal to the computer corresponding to an identifying symbol located on a page for identifying a passage of text on the page for operating the computer to display data relating to the subject matter of the passage of text corresponding to the identifying symbol.

In another embodiment of the invention the feature identified on the page by the identifying symbol is a passage of text.

The advantages of the invention are many. The apparatus according to the invention operates as an interface between a hard copy manual and a computer having additional data relating to that in the manual stored therein, and for facilitating ready selection of the data for display by the computer. In particular, the method and apparatus are particularly suitable for use by those who are not computer literate, and for those who may be intimidated by a computer, since the additional data can readily easily be selected and displayed without the need to input references to the data to be displayed through a computer keyboard, or through a mouse. All that is required is to place the carrier means on the page for reading the identity code thereon for identifying and transmitting particulars of the page to the computer, and then selecting the additional data by inputting the appropriate identifying symbol through the input means corresponding to the subject matter on the page for which the additional data is required. Where the input means is provided by a plurality of input keys which carry respective identifying symbols, all that is required is to press the appropriate key to input the identifying symbol for selecting the additional data relating to the subject matter of a passage on the identified page of the manual.

Another advantage of the apparatus according to the invention is that it permits the provision of additional data in soft copy form which could not easily be provided in hard copy form which can be readily easily accessed by a user of the manual.

Further advantages of the invention are achieved by virtue of the fact that once the page has been identified and relayed to the computer, and once the subject matter the additional data on which is required is communicated to the computer by inputting the appropriate identifying symbol, a user is not limited to obtaining data stored in the computer. For example, the computer may be programmed that when certain identifying symbols are selected for certain identified pages, the computer may dial up a website or the like of a particular supplier of equipment, and it is envisaged that a user could then scroll through the pages of the website by inputting appropriate signals through the input means on the carrier means. Further, the computer may be programmed for facilitating transactions to be carried out over the internet, for example, the purchasing of equipment, components and/or articles over the internet using signals inputted through the input means, and credit card details or purchase order numbers could be inputted through the input means on the carrier means for relaying to the computer for in turn transmitting over the internet or other suitable medium to the supplier of the goods.

A particular advantage of the invention is that a user of the manual who wishes to obtain data relating to a specific passage of text on an opened page is effectively provided with the data which is displayed on a visual display unit almost instantaneously, and it appears to the user that the data is being displayed instantaneously with the request. This is achieved by virtue of the fact that the opened page is immediately identified on the page being opened and the carrier member being brought into engagement with the page, and thus, data relating to passages of text on the page can be read-ahead by the computer. Thus, on a user entering a select signal through the input means identifying the passage of text for which the data is required to be displayed, the data to be displayed is ready for selection, and in turn, for display. It has been found that once a response occurs within 0.5 seconds of a command, the response is perceived by a user as being instantaneous with the command. Accordingly, by having the data for an opened page read-ahead and ready for selection and display, the data can be displayed within 0.5 seconds of the select signal being entered through the input means. The apparent instantaneous display of data is further enhanced where the apparatus is provided with a detecting means for detecting page turning so that if the data is to be read in from a CD-ROM or other medium into the computer prior to selection and display, the CD-ROM drive can be operated to bring the CD-ROM up to speed while a page is being turned, so that when the identifying signal identifying the opened page is relayed to the computer, the computer can immediately read in the data from the CD-ROM or other storage medium relating to the opened page. In this way the data is ready for immediate selection and display on receipt of the select signal identifying the passage of text for which the data is to be displayed. Furthermore, diversion of a user's attention initially to the manual and then to a display screen extends the period during which a user perceives the computer response to be near instantaneous, due to the fact that the user must first focus on the manual, and then on the display screen.

The apparatus according to the invention has also many advantages in a lecturing environment, where a lecturer and students would be provided with the manuals according to the invention, and during the course of the lecture additional data could be selected by the lecturer or the students for display during the course of the lecture. Such additional data would be selected by entering a select signal through the input means for selecting the desired additional data. The additional data may be stored in a computer with which the apparatus would communicate, or could be retrieved from a central store via an external communication link established by the computer.

The invention and its many advantages will be readily apparent to those skilled in the art from the following description of some embodiments thereof, which are given by way of example only, with reference to the accompanying drawings, in which:

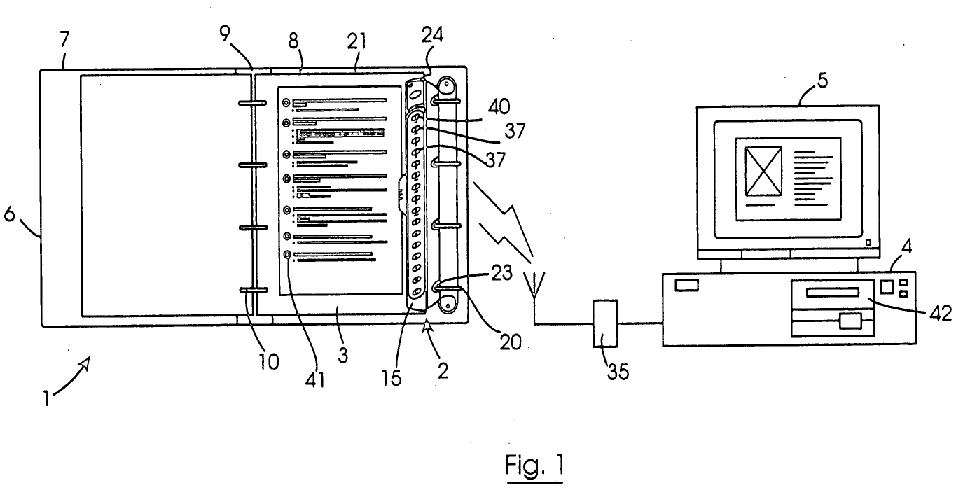

FIG. 1 is a front elevational view of a combination according to the invention of a manual also according to the invention and a computer, whereby the manual comprises apparatus according to the invention for transmitting the identity of a page of the manual to the computer and for facilitating the inputting of a select signal for transmission to the computer for operating the computer to display additional data relating to the manual,

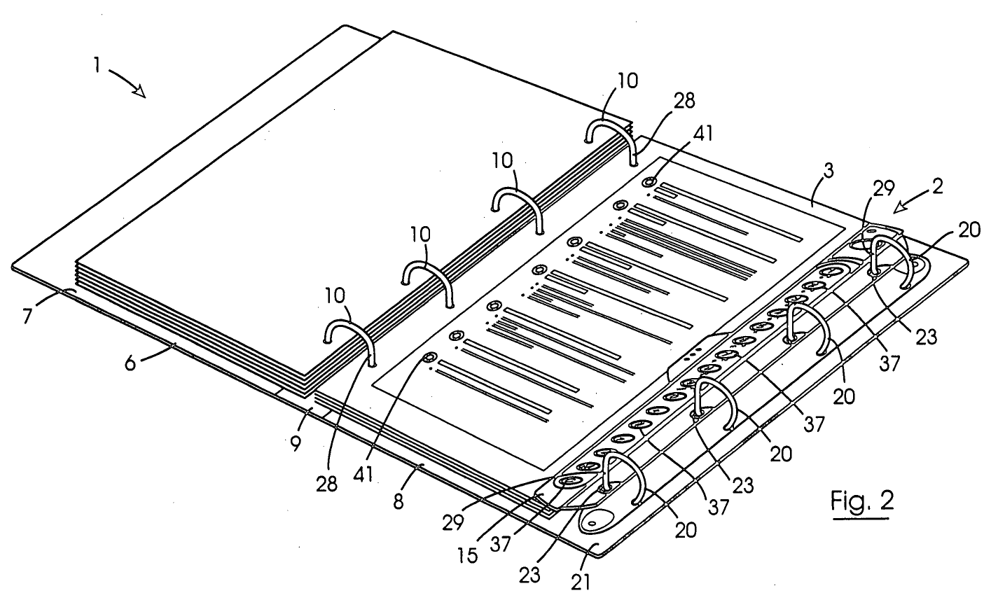

FIG. 2 is a perspective view of the manual of FIG. 1 illustrating the apparatus also of FIG. 1 in a similar position on the manual as illustrated in FIG. 1,

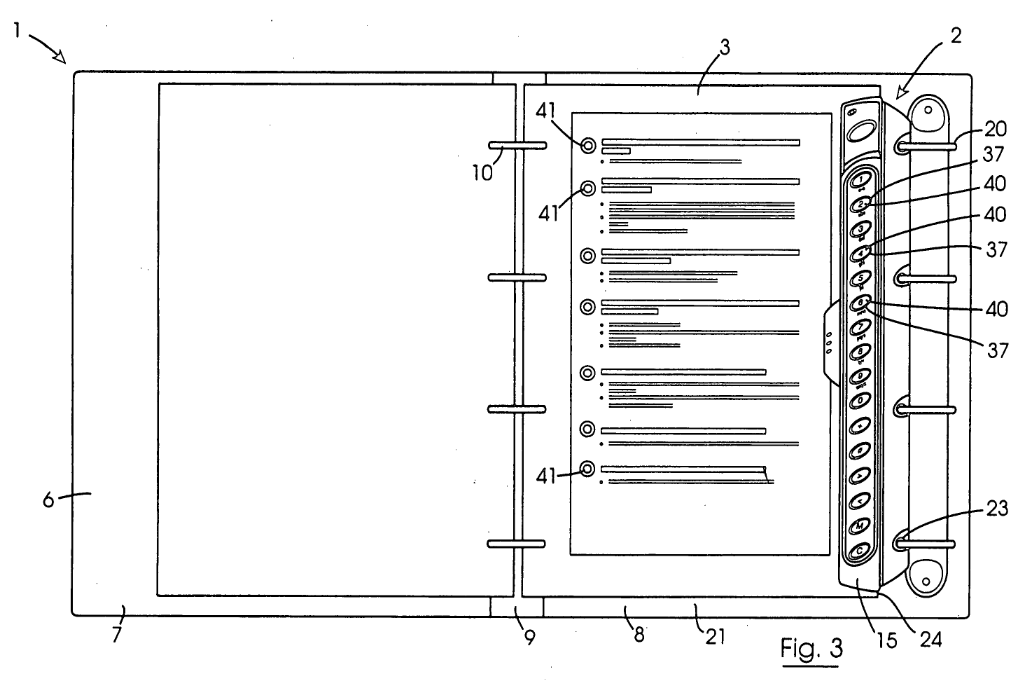

FIG. 3 is a front elevational view of the manual of FIG. 1 with the apparatus of FIG. 1 in the same position as illustrated in FIG. 1,

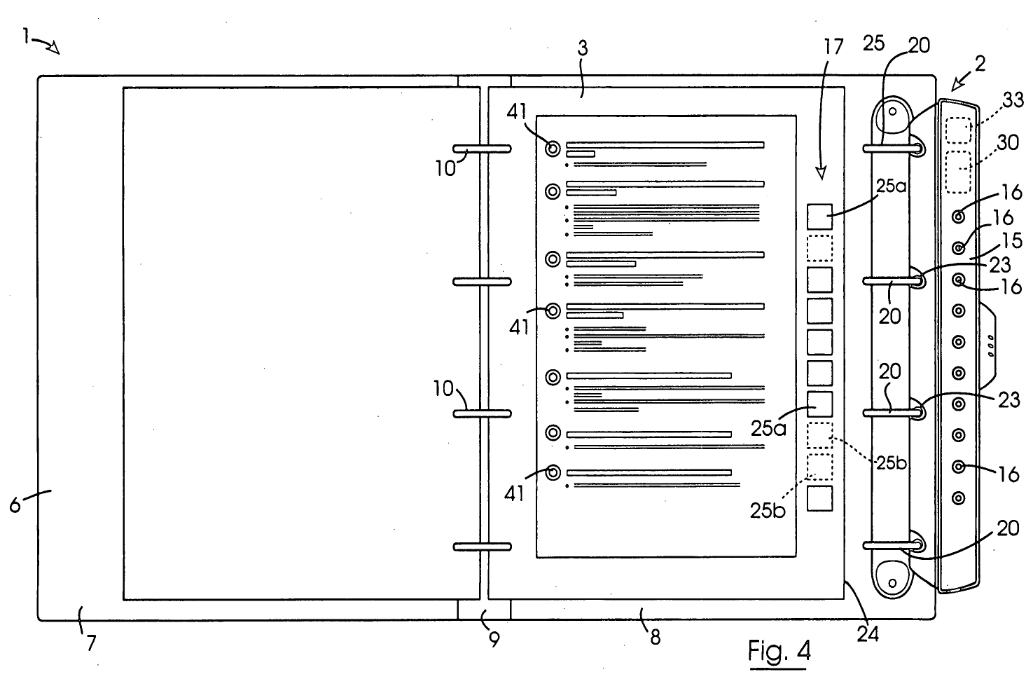

FIG. 4 is a front elevational view of the manual of FIG. 1 with the apparatus of FIG. 1 illustrated in a different position,

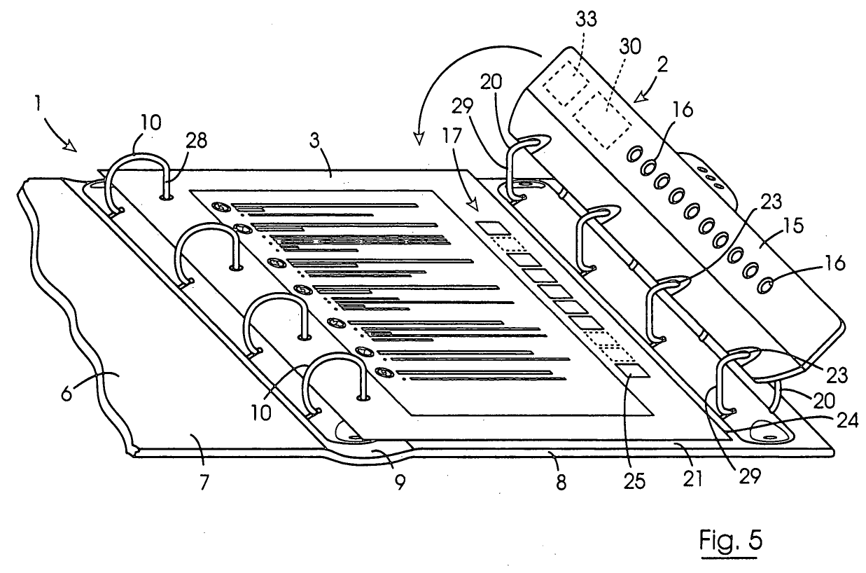

FIG. 5 is a perspective view of a portion of the manual of FIG. 1 illustrating the apparatus of FIG. 1 in a further different position,

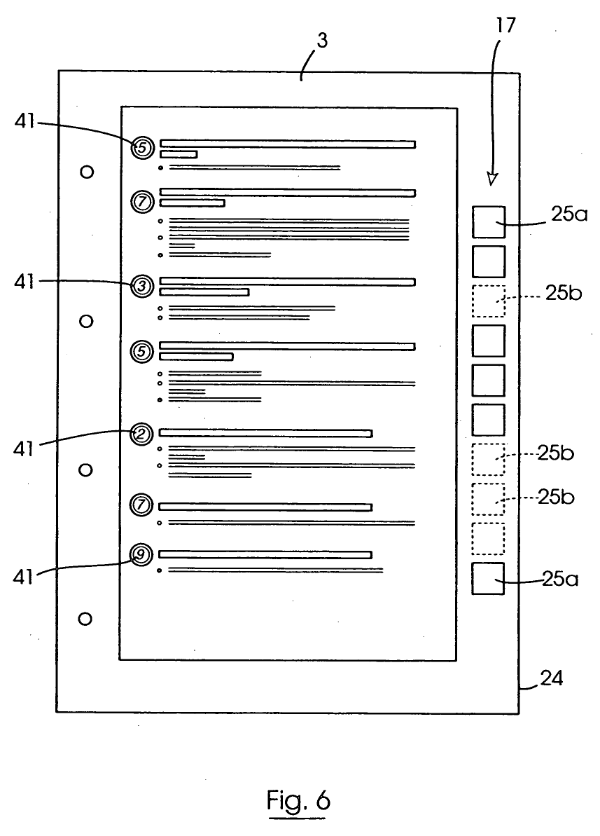

FIG. 6 is a front elevational view of a page of the manual of FIG. 1,

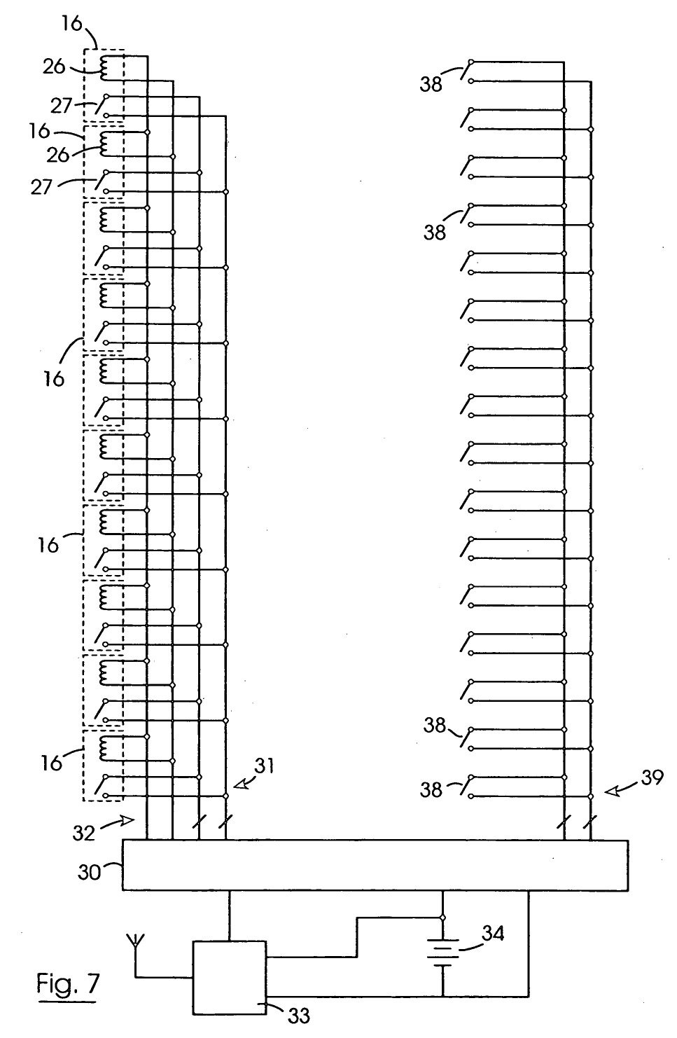

FIG. 7 is a block representation of a circuit of the apparatus of FIG. 1,

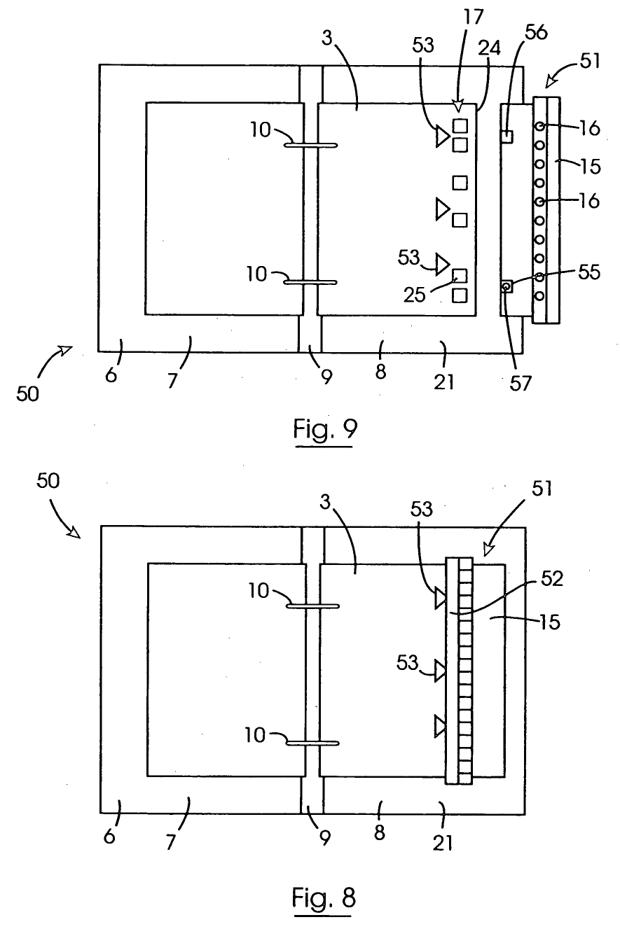

FIG. 8 is a front elevational view of a manual according to another embodiment of the invention,

FIG. 9 is a front elevational view of the manual of FIG. 8 illustrating apparatus also according to another embodiment of the invention of the manual of FIG. 8 in a different position, and

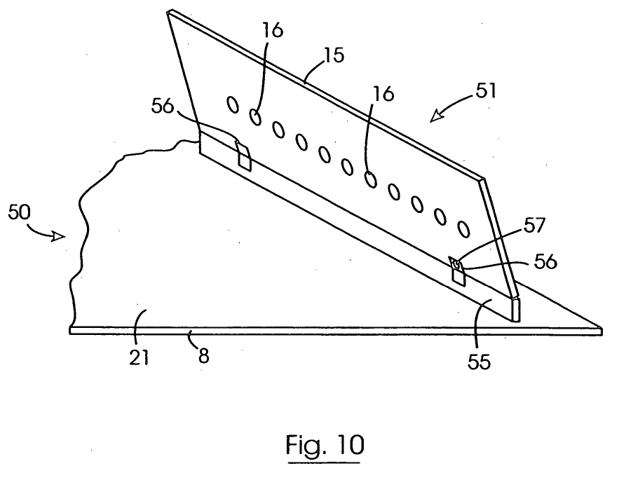

FIG. 10 is a perspective view of a detail of the manual of FIG. 8.

Referring to the drawings and initially to FIGS. 1 to 7, there is illustrated a hard copy manual according to the invention, indicated generally by the reference numeral 1, which comprises apparatus also according to the invention and indicated generally by the reference numeral 2 for identifying an opened page 3 of the hard copy manual 1 and for relaying the identity of the opened page 3 to a computer 4 so that additional data relating to a topic discussed on the identified opened page 3 can be displayed by the computer 4 on a visual display unit 5. The additional data, as will be discussed below, may be stored in the computer 4 or accessed externally by the computer 4.

The manual 1 comprises a binder 6 having a front cover 7 and a rear cover 8 which are joined by a central spine 9. Four page engaging rings 10 secured to the spine 9 releasably retain the pages 3 of the manual 1 in the binder 6, and facilitate turning of the pages 3. The manual 1 comprising the binder 6 and the pages 3 is similar to any such conventional hard copy manual.

The apparatus 2 comprises a carrier means provided by an elongated carrier member 15, which carries a reading means comprising a plurality of photo sensors 16 for reading an identity code 17 on each page 3 of the manual 1. Four carrier rings 20 secured to an inner surface 21 of the rear cover 8 of the binder 6 swivelably connect the carrier member 15 to the binder 6, so that the carrier member 15 is swivelably moveable on the carrier rings 20 between a reading position illustrated in FIGS. 1, 2 and 3 with the carrier member 15 overlaying a portion of the opened page 3 for reading the identity code 17 thereon, and an inoperative position illustrated in FIG. 4 clear of the pages 3 for facilitating turning of the pages 3. The four carrier rings 20 engage corresponding eyelets 23 in the carrier member 15.

In this embodiment of the invention the identity codes 17 for identifying the respective pages 3 of the manual 1 are provided as binary codes. Each identity code 17 comprises ten discrete locations 25 provided along a side edge 24 of each page 3. The discrete locations 25 of each identity code 17 are either printed with black ink, namely, the locations 25a, to indicate the binary code one, or left blank, in other words, unprinted, namely, the locations 25b, to indicate the binary code zero. Typically, the pages 3 will be of white paper so as to maximise the contrast between the black printed discrete locations 25a which prevent light reflection indicating the binary code one, and the unprinted discrete locations 25b which maximise light reflection indicating the binary code zero.

The photo sensors 16 are longitudinally aligned along the carrier member 15, and are located at spaced apart locations, one photo sensor 16 being provided corresponding to each discrete location 25, so that when the carrier member 15 is in the reading position the photo sensors 16 are aligned with the corresponding discrete locations 25. Each photo sensor 16 comprises a light emitter 26 and a light detector 27 for detecting the presence or absence of reflected light from the corresponding discrete location 25 from the light emitter 26, see FIG. 7. In order to facilitate light transmission from the light emitter 26 of each photo sensor 16 to the corresponding discrete location 25 and to facilitate reflection of light therefrom for collection by the light detector 27, each photo sensor 16 terminates in a concave surface for abutting the opened page 3 for facilitating reflection of light emitted by the corresponding light emitter 26 from the discrete location 25 to the light detector 27.

In this embodiment of the invention the photo sensors 16 are only read by the microprocessor 30 on activation of the light emitters 26 in order to avoid any danger of spurious signals being read from the photo sensors 16 by the microprocessor 30. Any suitable light emitters may be used, for example, infrared, white light or the like. Invalid codes from the photo sensors 16 which are determined by the microprocessor 30 as being invalid are not transmitted to the computer 4 by the microprocessor 30. Additionally, in order to minimise spurious signals being transmitted to the computer, certain combinations of code are not allowed. For example, all binary ones and all binary zeros are not allowed.

The page engaging rings 10 each comprise vertical legs 28, and the carrier rings 20 also comprise vertical legs 29. The vertical legs 28 and 29 of the respective page engaging rings 10 and carrier rings 20 are so arranged to ensure that as the number of pages 3 beneath the carrier member 15, when the carrier member 15 is in the reading position, increases or decreases, the photo sensors 16 will always be aligned with their corresponding discrete locations 25 of the binary identity codes 17 on the opened page 3.

A microprocessor 30 located in the carrier member 15 reads signals from the photo sensors 16 for identifying the opened page 3, and converts the signals read from the photo sensor 16 into a suitable signal for relaying to the computer 4. A bus 31 couples the light detectors 27 of the photo sensors 16 to the microprocessor 30 for reading thereof. The light emitters 26 are powered by a power supply cable 32 under the control of the microprocessor 30.

A communicating means, in this embodiment of the invention a radio transmitter 33 is located in the carrier member 15, and is operated under the control of the microprocessor 30 for transmitting signals to the computer 4 identifying the opened page 3 of the manual 1.

A long life lithium disc shaped battery 34 powers the microprocessor 30, as well as the photo sensors 16 and the transmitter 33.

A radio receiver 35, which is tuned to the transmitter 33, and which communicates with the computer 4 receives the signals transmitted by the radio transmitter 33 for relaying to the computer 4 for operating the computer 4 under the control of the apparatus 2 as will be described below.

An input means comprising a plurality of input keys 37, in this embodiment of the invention sixteen input keys 37, are located along the carrier member 15, and communicate with the microprocessor 30 for facilitating the inputting of select signals for relaying to the computer 4 for selecting additional data to be displayed by the computer 4 on the visual display unit 5 relating to subject matter discussed in the opened page 3. The input keys 37 operate corresponding switches 38, which are coupled to the microprocessor 30 through a bus 39. Each input key 37 carries a unique identifying symbol 40, and in this embodiment of the invention most of the identifying symbols 40 are similar to corresponding symbols carried on the keys of a mobile phone. The symbols 40 carried by ten of the input keys 37 are the digits one to nine and zero, respectively, as well as the letters A to Z arranged in groups as they would be on the keypad of a mobile phone. The identifying symbols 40 carried by the remaining keys 37 are an asterisk/plus symbol, a hash symbol, a greater than arrow symbol and a less than arrow symbol. Additionally, one of the input keys 37 carries the symbol of a capital letter M, and the last of the keys 37 carries the symbol of a capital letter C. The ten input keys 37 which carry the digits one to nine and zero are used for inputting select signals to the microprocessor 30 for identifying a passage of text on a page in relation to which additional data is to be displayed on the visual display screen 5, as will be described below. The input keys 37 which carry the asterisk/plus symbol, the hash symbol, the greater than arrow symbol and the less than arrow symbol are effectively used for inputting signals for operating the computer 4 after the selected data has been displayed, as will also be described below. The input key 37 carrying the capital letter M identifying symbol is a MENU key, which permits a user to call up a menu of the additional data which has been selected or may be selected in respect of a passage of text on the opened page for display. The input key 37 which carries the capital letter C identifying symbol is a CANCEL key for facilitating cancellation of the display of data when the user is finished viewing the displayed data, or for terminating other routines being carried out by the computer 4. The input key 37 which carries the capital letter C identifying symbol may also be used for cancelling other operations of the computer 4.

Some or all of the pages 3 of the manual I carry a plurality of identifying symbols 41 adjacent respective passages of text, and each identifying symbol 41 identifies the corresponding adjacent passage of the text. The identifying symbols 41 are the digits one to nine and zero, and are thus similar to the identifying symbols 40, namely, the digits one to nine and zero carried on the input keys 37. The identifying symbols 41 comprising the digits one to nine and zero are printed on the page and encircled. Thus, if a user wishes to obtain additional data or information relating to a particular passage of the text of the opened page 3, the input key 37 carrying the identifying symbol 40 corresponding to the identifying symbol 41 adjacent the relevant passage of text on the opened page 3 is pressed, thereby providing a select signal to the microprocessor 30. The microprocessor 30, which has already identified the opened page 3 and relayed its identity to the computer 4, identifies the input key 37 which has been depressed, and relays a corresponding select signal to the computer 4 through the transmitter 33 for operating the computer 4 to display the additional data relating to the identified passage in the text of the identified page. The input key or keys 37 carrying the appropriate operating identifying symbol can then be pressed by the user to operate the computer 4 to display the data in a desired fashion, for example, to scroll the data, to select specific parts of the data for display or the like.

In general, the additional data for all pages 3 of the manual 1 will be stored on a CD-ROM (not shown), and read into and stored in the computer 4 through a CD-ROM reader 42. Alternatively, in cases where a large amount of additional data is stored on a CD-ROM (not shown), the data when selected may be read by the computer 4 directly from the CD-ROM (not shown) and displayed directly by the computer 4 on the visual display unit 5. However, in such cases in order to minimise delays in displaying the additional data, the CD-ROM (not shown) is brought up to speed as each page 3 of the manual 1 is turned. The microprocessor 30 on detecting a change in the signals received from the photo sensors 16, determines that a page 3 of the manual 1 is being turned, and on detecting such a change in the photo sensor signals, transmits a signal to the computer 4, which instructs the computer to bring the CD-ROM reader 42 up to speed.

The signals which are transmitted by the microprocessor 30 through the radio transmitter 33 are packaged into digital data in an appropriate protocol by the microprocessor 30, and transmitted through the transmitter 33. The received data packages which are received by the radio receiver 35 are relayed by the radio receiver 35 to the computer 4. While any suitable communications protocol may be used for communicating between the radio receiver 35 and the computer 4, it is preferred that a smart protocol will be used, for example, USB or FireWire.

A suitable software driver (not shown) is provided in the computer 4 for operating the computer in response to the signals received from the microprocessor 30.

In use, with the apparatus 2 and the computer 4 powered up, and with the additional data on the CD-ROM (not shown) read in from the CD-ROM and stored in the computer 4, or with the CD-ROM ready in the CD-ROM reader 42 of the computer 4, the apparatus 2 and computer 4 are ready for use. A user in the course of using the manual 1 who wishes to obtain additional information on a particular topic in the manual 1 turns to the appropriate page 3 of the manual 1. The carrier member 15 is then swivelled on the carrier rings 20 from the inoperative position to the reading position to overlay the opened page 3 adjacent the edge thereof so that the photo sensors 16 are aligned with the discrete locations 25. The microprocessor 30 reads the photo sensors 16 for determining the identity code 17 on the opened page 3 for in turn identifying the opened page 3, and transmits the identity of the opened page 3 to the computer 4 through the transmitter 33. The user then identifies the identifying symbol 41 which is located adjacent the passage of text on the opened page 3 about which the additional data is required, and depresses the input key 37 which carries the corresponding identifying symbol 40. The microprocessor 30 on reading the switches 38 of the input keys 37 identifies the input key, which has been pressed. The microprocessor 30 then transmits the select signal, which identifies the identifying symbol through the transmitter 33 to the computer 4. On receiving the select signal, since the computer 4 already has received the identity of the opened page 3, the computer 4 identifies the passage of text about which the additional data is required and retrieves the additional information from that stored in the computer from the CD-ROM, and the additional data is displayed on the visual display unit 5. The user by using the input key 37 which carries the less than arrow symbol may then scroll through the additional data on the visual display unit 5. The microprocessor 30 and the computer 4 are appropriately programmed so that when the additional data is displayed on the visual display unit 5, operation of the input key 37 which carries the less than arrow symbol scrolls the additional data.

Additionally, on the microprocessor 30 detecting a change in the signals read from the photo sensors 16 indicating that the carrier member 15 is being swivelled for facilitating turning of a page 3, the microprocessor 30 also transmits a signal through the transmitter 33 to the computer 4 to indicate to the computer 4 that a page 3 in the manual 1 is being turned. On receiving this signal, if the additional data is being read and displayed directly from the CD-ROM, the computer 4 operates the CD-ROM reader 42 to bring the CD-ROM up to speed, so that when the signals identifying the opened page 3 and the appropriate identifying symbol 41 identifying the passage in the text for which additional data is required is transmitted to the computer 4, the CD-ROM will be operating up to speed, and the additional data can be readily read directly from the CD-ROM and displayed on the visual display unit 5. However, where the additional data has already been read from the CD-ROM and stored in the computer 4, the signal transmitted by the microprocessor 30 indicating a page turning is ignored by the computer 4.

Additionally, the computer 4 may be programmed to co-operate with the apparatus 2 so that when certain input keys 37 are depressed for requesting additional data for specific pages 3, the additional data may be called up by the computer 4 from a source other than additional data stored in the computer 4 or on a CD-ROM, for example, the additional data may be called up over the internet, and may be provided in a central storage bank which is accessible to users of the apparatus 2 via the computer through an external communications link. Further, it is envisaged that if, for example, the manual were a manual for operating and maintaining machinery, when certain input keys 37 are depressed for requesting additional data for certain pages 3, the computer may be programmed to dial up a website of a supplier of parts or components for the machinery, and by operating the input keys 37 according to instructions printed on the opened page 3 the user may scroll through pages of the website to identify a part or component required for the machinery. Further, the computer may be programmed to permit a user to purchase a required component or part over the internet, and the user would enter a purchase order number, if the user had an account with the supplier of the component or part, or alternatively, a credit card number through the input keys 37 which carry the digits one through nine and zero.

An advantage of providing the identifying symbols on the input keys 37 which are similar to those on a mobile phone is that a user will be familiar with a mobile phone keypad, and by appropriately programming the microprocessor 30 and the computer 4, the user will be able to perform the same kind of operations as is possible with a mobile phone using text and number entries and menu navigation, etc. as would be used on a mobile phone, particularly when a user is in communication with a website or ordering a component part or the like over the internet or other suitable external communications link.

In general, in order to conserve power, the components on the carrier device are operated to remain in a low power state with the microprocessor 30 powered down. In this state current consumption is relatively low and is in the order of one to two microamps. Consequently, sleep state current consumption is of negligible importance. The microprocessor 30 wakes up at regular intervals to check for page changes. If no activity is detected, it returns to sleep. The check intervals are set to around four times per second.

Needless to say, it will be readily apparent to those skilled in the art that the computer may be any suitable type of computer, for example, a personal computer (PC), a laptop computer, or indeed, a mainframe computer.

Referring now to FIGS. 8 to 10, there is illustrated a manual according to another embodiment of the invention, indicated generally by the reference numeral 50. The manual 50 is substantially similar to the manual 1, and similar components are identified by the same reference numerals. The manual 50 comprises apparatus 51, which is also substantially similar to the apparatus 2, for identifying an opened page 3, and for transmitting the identity of the page 3 and a select signal inputted through the input keys 37 to a computer 4 for operating the computer 4 to display additional data on a visual display unit 5 in similar fashion as the apparatus 2. Components of the apparatus 51 which are similar to those of the apparatus 2 are identified by the same reference numerals. The main difference between the apparatus 51 and the apparatus 2 is in the input means. In this embodiment of the invention instead of the input means being provided by a plurality of input keys 37, the input means comprises a resistive touch strip 52. Identifying symbols in the form of arrowheads 53 are located on each page 3 adjacent the passages of text to which they correspond. Thus, a person wishing to obtain additional information on a specific passage of text adjacent one of the arrowheads 53 presses the touch strip 52 adjacent the corresponding arrowhead 53. The microprocessor 30 reads the signal from the touch strip 52, and from the analogue value of the voltage signal resulting from touching of the touch strip 52 the microprocessor 30 determines the location at which the touch strip 52 is depressed, and in turn the selected arrowhead 53 of the corresponding passage of the text. A select signal identifying the passage of text for which the additional data is required is transmitted to the computer 4. The identity of the opened page 3 would already have been transmitted to the computer 4. The additional data is displayed by the computer 4 on the visual display unit 5 as already described, or alternatively, the computer logs on to a central data bank, an appropriate website or the like in a similar manner to that already described with reference to the apparatus 2, in order to retrieve the data for display on the visual display unit 5.

Additionally, in this embodiment of the invention the carrier member 15 instead of being swivelably carried on carrier rings is carried on a support member 55 which extends substantially perpendicularly from the inner surface 21 of the rear cover 8 of the binder 6. Hinges 56 pivotally connect the carrier member 15 to the support member 55 so that the carrier member 15 is pivotal between the inoperative position illustrated in FIG. 9 and the reading position illustrated in FIG. 8. A proximity sensor 57 is located in the carrier member 15 for detecting relative movement of the carrier member 15 relative to an opened page 3 or the rear cover 8 of the binder 6 for indicating a possible page turning. In this embodiment of the invention a signal is transmitted by the microprocessor 30 to the computer 4 in response to the microprocessor 30 reading a signal from the proximity sensor 57 indicating movement of the carrier member 15 for in turn indicating to the computer 4 the possibility of a page turning commencing for bringing the CD-ROM up to speed, should this be required. In this embodiment of the invention the proximity sensor 57 is provided instead of programming the computer 4 to respond to changes in the signals from the photo sensors 16 for transmitting a signal to the computer 4 indicating page turning.

While in the apparatus 2 and 51 signals identifying the identity code of an opened page and signals identifying a selected identifying symbol have been described as being transmitted to the computer separately, it is envisaged that in certain cases the identity code of an opened page would not be transmitted to the computer until an identifying symbol had been inputted through the input keys 37, and in which case, the identity code of the page and the select signal corresponding to the selected identifying symbol would be packaged into a single digital data package and transmitted to the computer 4. This would require the identity code of an opened page to be packaged and transmitted each time an identifying symbol had been selected.

While the apparatus 2 and the apparatus 51 have been described as comprising a carrier member 15 in which the communication means in the carrier means for communicating with the computer 4 is provided by a radio transmitter, in certain cases, it is envisaged that the communicating means on the carrier member 15 may be provided by a radio transceiver, and the receiver for the computer 4 would also be provided by a radio transceiver. This would permit two-way communications between the apparatus 2 and the computer 4. This would have the added advantage of facilitating disabling an apparatus 2 or 51, in the event that a plurality of apparatus were in use with the same computer. For example, in a lecturing situation where a lecturer would have a manual, and each of the students would likewise have their own manual, the lecturer could communicate with the computer through the apparatus of his or her manual for facilitating enabling of his or her apparatus and disabling the apparatus of the students. During the progress of the lecture, the students' apparatus could be sequentially enabled by the lecturer with appropriate commands through his or her apparatus, thus permitting the students to sequentially select additional data to be displayed on the visual display unit.

It is also envisaged that where a number of apparatus are communicating with the same computer, each of the apparatus would be provided with their own unique identity, and when transmitting a data package comprising the identity of an opened page and/or an identifying symbol, the identity of the apparatus would also be included in the data package. The computer would then determine whether the packaged data from that apparatus was entitled to obtain the additional data or otherwise, and if so, the additional data would be displayed on the visual display unit, otherwise, the data package would be deleted by the computer or alternatively stored for use subsequently when the user would be entitled to view the additional data. Other identification systems may be incorporated in the radio receiver 35 to create a link between the manual, the computer and a specific user, for example, contact ID devices, such as a smart card, contactless ID devices, such as an RFID tag, and/or biometric ID, such as a fingerprint scanner. Such identification systems will be well known to those skilled in the art.

The software for operating the computer in response to signals and data packages received from the apparatus 2 and 51 can be supplied separately or with the CD-ROM which comprises additional data. Such methods of providing software will be well known to those skilled in the art. Additionally, the software required for operating the computer in response to the data packages and signals received from the apparatus 2 and 51 may be suitable for operating in a Windows environment, for example, in conjunction with Microsoft Windows.

It is also envisaged that the identity code on some of the pages of the manual, for example, the first few pages of the manual, may be arranged to actually identify the manual itself. For example, the code appearing on the first few pages of the manual may include ISBN publication number assigned to the manual. A unique bit symbol would indicate that the page identity code on the first few pages of the manual form part of the book ISBN publication number. Successive reading of the first few pages in sequence would build up a full book code which could be as long as thirty-two to sixty-four bits. Typically, ISBN codes are ten decimal digits (ten billion codes), which can be represented in sixty-four bits. It is also envisaged that additional bit symbols may be added to each page identity code for increasing the reliability of the detection of the page identity codes. These bits would include check bits, which would verify the validity or otherwise of a red identity code. Spurious codes could then be rejected.

The additional data which may be displayed on the visual display unit may be any type of data, and may be displayed in any type of format. For example, the additional data may be provided as a Word document, in Excel, PowerPoint, Acrobat, Flash and many other formats. The additional data may be multimedia, spreadsheet data, chart data, graphical data, and in certain cases, the additional data may be animated, in the form of a movie, such as in the form of a video, with audio and other content, and may be animated or otherwise.

It is envisaged that both the apparatus and the computer may be provided with transceivers as already discussed. By providing bi-directional transmission, acknowledgement of received signals would be permitted, thereby offering reliable end to end delivery, retransmission in the event of corrupt data or collision occurring where multiple apparatus are used with a single computer, as well as additional control of the computer.

By providing two-way communication between the apparatus and the computer, specific apparatus may be readily disabled and re-enabled under the control of the computer, and indeed, under the control of one of the apparatus which may be designated a master apparatus, for example, in a lecturing situation the apparatus of the lecturer may be designated as a master apparatus, and the other apparatus could be controlled through the computer by the master apparatus.

Additionally, in order to minimise the,power required to operate the apparatus 2 and 51, the light detectors and the light emitters of the photo sensors may be banked or multiplexed, so that groups of photo sensors would be individually activated, this would also reduce the number of input/output pins required on the microprocessor 30.

While specific mounting arrangements have been described for mounting the carrier member to the manual, any other suitable mounting arrangements or methods may be used. Indeed, in certain cases, it is envisaged that the carrier member may be provided as a separate portable unit which would not be connected to the manual. Needless to say, while the apparatus has been described as comprising a carrier means of a particular type for carrying the reading means, the input means, the microprocessor and the transmitter, any other suitable carrier means may be provided, and as mentioned above, the carrier means may be provided as a separate portable unit, which would be separate from the manual.

While the communicating means has been described as comprising a receiver/transmitter arrangement and/or two transceivers, it is envisaged in certain cases that the apparatus may be hardwired to the computer. Additionally, while the apparatus has been described as being for use with a manual, the apparatus is suitable for use with any book, ledger, encyclopaedia or any other arrangement where pages are combined into a book, manual or booklet form.

It will also be appreciated that other suitable identity codes for identifying the pages besides a binary code may be used. For example, in certain cases, the identity code may be provided in the form of a barcode. Additionally, while the identifying code has been described as being provided in the form of a binary code comprising ten bits, namely, the ten discrete locations, the identifying code, when provided as a binary code may be provided with any number of bits, and where a page is large enough, it is preferable that the binary code should have the maximum number of bits which could be appropriately fitted onto the page. Where possible, it is preferable that the binary code should be a sixteen bit code, however, where the page is a relatively small page, the number of bits may be considerably less than sixteen, and indeed, may be less than ten. Needless to say, the number of bits of the binary code may be greater than sixteen also if desired.

Needless to say, the identity code may be provided in any suitable or desirable location on the pages. It will also be appreciated that other identifying symbols besides those described may be provided on the input keys and on the input pages, and it will be readily apparent to those skilled in the art that instead of providing the input means in the form of input keys as described with reference to the apparatus 2, the input means may be provided by an elongated resistive strip as described with reference to the apparatus 51, and in which case, identifying symbols may be provided on the strip spaced apart along the length of the resistive strip touch strip. Likewise, instead of providing identifying symbols on the input keys of the apparatus as described with reference to the apparatus 2, it is envisaged that arrowheads or other suitable identifying means may be provided on the pages adjacent the location of the input keys, and where it is desired to obtain additional information in respect of a passage of text adjacent a particular arrowhead, the input key adjacent the arrowhead on the opened page would be depressed for selecting the appropriate additional data.

While the reading means have been described as being provided by photo sensors, any other suitable reading means may be provided. It will also be appreciated that any other suitable detecting means for detecting movement of the carrier means relative to a page or the manual besides a proximity sensor as described with reference to the apparatus 51 may be used. For example, it is envisaged that a rotary sensor or a rotary encoder may be incorporated in one of the hinges for detecting pivoting of the hinge, and in turn, pivoting of the carrier member, thus indicating pivoting of the carrier member, which in general would indicate turning of a page.

While the additional data has been described as being stored and provided on a CD-ROM, the additional data may be stored on any other suitable storage medium.

A further additional advantage of the invention is that irrespective of whether the carrier member is connected to the manual or not, where the reading means for reading the identity code on a page for identification thereof, and the input means for inputting a select signal for identifying a passage of text on a page in relation to which additional data is required, the apparatus according to the invention provides a single integral unit, namely, the carrier member or carrier means which incorporates the reading means and the input means for facilitating both identification of a page by reading an identifying code thereon and for inputting a select signal for identifying a passage of text on the page in relation to which additional data is required, which in turn facilitates communicating both the identity of the page and the identity of the passage of text in relation to which additional data is required to a computer for displaying the additional data. The provision of such apparatus as an integral unit has many of the advantages discussed in the specification, and in particular, facilitates the selection of the additional data by a user without the need for entering commands through a keyboard of a computer or through a mouse.

Thus, the apparatus when provided in the form of a carrier member with a reading means and an input means as a single integral unit firstly, as a first step identifies a page, and then allows a further level of discrimination by using the input means in order to select data within the total page related content. In addition, the online content may be programmed to allow a specific input key of the input means, for example, the key carrying the menu symbol M, to cause the online content to jump into a new mode, such as a calculator application, which would then capture all input key strokes until a certain key sequence terminates the function, for example, the cancel key carrying the identifying symbol of the capital letter C. In this mode the page-code-scanning function and the input key scanning function are no longer linked to the physical page, but have jumped off the page into a space controlled and defined by the invoked application, for example, the original page key combination could invoke Internet Explorer, which would at this stage be driven directly by the input keys through the software driver, to access a web page. This would permit the ordering of products over the internet, or obtaining information over the internet. All input key strokes and output displayed on the computer screen would now have absolutely nothing to do with the original page content, which merely acts as an entry point to a new virtual space. Furthermore, the apparatus could remain in this mode, and could hop from application to application for as long as required. Finally, the mode could be terminated through a specific key sequence to jump back onto the page. This feature would allow the apparatus according to the invention to function, not only as a page code scanner, but also as a true input device offering an alternative to many conventional keyboard and mouse functions.

Needless to say, it will be appreciated that the apparatus according to the invention may be used with any other series of pages, whether in a manual form, a book form, a magazine form, journal, loose pages or the like, where at least some of the pages carry an identifying code.

Furthermore, while the identifying symbols have been described for identifying passages of text on a page, in respect of which additional data is required to be displayed by the computer, the identifying symbols may be used for identifying any item on a page, in respect of which additional data is required. For example, the identifying symbols may identify a heading or sub-heading on a page, in respect of which additional data is required. Additionally, the identifying symbols may be used for identifying a sketch, a drawing, a feature of a drawing, an instruction, or the like, in respect of which additional data is required.

What is claimed is:

1-57. (canceled)

58. Apparatus for identifying a page of a plurality of pages and for relaying the identify of the page to a computer, characterized in that the apparatus comprises a carrier means, a reading means carried on the carrier means for reading an identity code on a page, and a communicating means for communicating the identity of the page to the computer.

59. Apparatus as claimed in claim 58 characterized in that the communicating means is carried on the carrier means.

60. Apparatus as claimed in claim 58 characterized in that the apparatus comprises a binder, in which the pages are retained, and the carrier means is operably mounted on the binder for co-operating with the pages for facilitating sequential reading of the identity codes on respective ones of the pages, and the binder comprises a front cover and a rear cover, and the carrier means is located on an inner surface of one of the front and rear covers, and preferably, the carrier means is located on the rear cover, and advantageously, the carrier means is located adjacent a side edge of the page opposite to a side edge of the page adjacent which the page is secured in the binder.

61. Apparatus as claimed in claim 60 characterized in that the carrier means is moveably connected to the binder, and is moveable between a reading position overlaying a portion of a page adjacent an edge thereof for reading the identity code thereon and an inoperative position clear of the page for facilitating turning of the pages in the binder, and preferably, the carrier means is swivelably connected to the binder, and advantageously, the carrier means is swivelably connected to the binder by a pair of spaced apart carrier ring connectors, and advantageously, each carrier ring connector comprises an upstanding limb extending substantially perpendicularly from the binder adjacent the page, so that the carrier means co-operates with each page with the reading means aligned with the identity code for reading thereof, and ideally, the binder is a ring binder having a pair of spaced apart page engaging rings, each-page engaging ring comprising an upstanding limb extending perpendicularly to the binder for locating the pages relative to the upstanding limb of the carrier ring connector with the distance of the identity codes from the upstanding limbs of the carrier ring connectors substantially constant.

62. Apparatus as claimed in claim 58 characterized in that each identity code is located on a portion of the corresponding page for co-operating with the reading means for reading thereof, and preferably, each identity code is a machine readable code, and advantageously, each identity code is printed on the corresponding page, and preferably, each identity code is a binary code comprising a plurality of discrete locations which are provided in one of two states for indicating a corresponding one of a binary one state and a binary zero state, and advantageously, each identity code comprises ten discrete locations, and ideally, the discrete locations forming the identity code on each page are aligned longitudinally along the page.

63. Apparatus as claimed in claim 62 characterized in that the reading means comprises at least one photo sensor for reading the identity code.

64. Apparatus as claimed in claim 63 characterized in that a plurality of photo sensors are provided, one photo sensor being provided corresponding to each discrete location of the identity code, and preferably, each photo sensor comprises a light emitter and a light detector for detecting the presence or absence of light reflected by the corresponding discrete location from the light emitter, and advantageously, the respective photo sensors are longitudinally aligned along the carrier means and are located thereon at spaced apart locations.

65. Apparatus as claimed in claim 58 characterized in that an input means is provided for facilitating inputting of a select signal for communicating to the computer for operating the computer to display data in response to the select signal.

66. Apparatus as claimed in claim 65 characterized in that the select signal for operating the computer to display data, operates the computer for displaying data relating to a feature on one of the pages.

67. Apparatus as claimed in claim 65 characterized in that an identifying symbol is provided for identifying a feature on a page for which data may be displayed by the computer, and preferably, a plurality of identifying symbols for identifying respective features are provided, and advantageously, appropriate ones of the identifying symbols are located on the page, and preferably, the appropriate ones of the identifying symbols are located on the page adjacent the corresponding feature, and ideally, the appropriate identifying symbols are printed on the page.

68. Apparatus as claimed in claim 65 characterized in that the input means is carried on the carrier means.

69. Apparatus as claimed in claim 65 characterized in that the input means comprises a plurality of input keys, and preferably, the respective input keys correspond to respective ones of the corresponding identifying symbols, and the input keys are identified by respective corresponding ones of the identifying symbols, and advantageously, some of the identifying symbols identifying the input keys are similar to those associated with keys of a mobile phone, and preferably, some of the input keys are provided for inputting select signals for controlling operation of the computer, and ideally, the input keys are spaced apart from each other.

70. Apparatus as claimed in claim 69 characterized in that the input keys are aligned longitudinally along the carrier means, and preferably, sixteen input keys are provided.

71. Apparatus as claimed in claim 65 characterized in that the input means comprises a longitudinally extending touch sensitive strip, and preferably, the touch sensitive strip outputs an analogue signal indicative of the location at which the touch sensitive strip is touched.

72. Apparatus as claimed in claim 58 characterized in that the carrier means comprises an elongated carrier member extending parallel to the adjacent edge of the adjacent page.

73. Apparatus as claimed in claim 58 characterized in that a microprocessor is located on the carrier means for receiving signals from the reading means and the input means for converting the signals into digital signals for communicating to the computer, and preferably, the communicating means comprises a radio transmitter for transmitting signals to the computer, and advantageously, the communicating means comprises a transceiver for transmitting and receiving signals to and from the computer, and preferably, a means is provided for detecting movement of the carrier means and for facilitating communication of a signal to the computer indicating that the carrier means is being moved for readying the computer to display data in the event of the inputting of a select signal through the input means.

74. A hard copy manual comprising a binder, a plurality of pages secured in the binder, at least some of the pages carrying an identity code for identification thereof, a carrier means located on the binder, a reading means carried on the carrier means for reading an identity code on a page of the hard copy manual, and a communicating means for communicating the identity of the page to a computer.

75. A hard copy manual as claimed in claim 74 characterized in that at least some of the pages have at least one identifying symbol for identifying a feature thereon, and an input means is provided for inputting a select signal corresponding to the identifying symbol for communicating to the computer for operating the computer to display data relating to the subject matter of the feature corresponding to the identifying symbol, and preferably, a computer characterized in that the apparatus communicates with the computer through the communicating means for indicating the identity of a page, and data relating to subject matter of the page is stored in or is accessible through the computer, and is selectable for display in response to a select signal communicated from the apparatus to the computer.

76. The combination as claimed in claim 75 characterized in that the computer is responsive to the select signal from the input means corresponding to one of the identifying symbols for displaying data relating to subject matter of a feature identified by the identifying symbol, and preferably, the computer is programmed to obtain the data to be displayed in response to the select signal from an external source over an external communications link, and advantageously, the computer is programmed to obtain the data to be displayed over the internet, and preferably, the computer is programmed for facilitating online transactions via an external communications link in response to signals inputted through the input means, and advantageously, the computer is programmed for facilitating the making of a purchase over the internet, and preferably, a radio receiver is provided associated with the computer for receiving signals transmitted by the transmitter of the apparatus and for relaying the received signals to the computer, and preferably, a transceiver is provided associated with the computer for receiving signals transmitted by the transmitter of the apparatus, and for transmitting signals to a corresponding transceiver of the apparatus.

77. A method for communicating the identity of a page of a plurality of pages to a computer, the method comprising the steps of reading an identity code on the page indicative of the identity of the page, and communicating the identity of the page to the computer through a communicating means.

78. A method as claimed in claim 77 characterized in that the method comprises the further step of inputting a select signal to the computer corresponding to an identifying symbol located on a page for identifying a feature on the page for operating the computer to display data relating to the subject matter of the feature corresponding to the identifying symbol, and preferably, the feature identified on the page by the identifying symbol is a passage of text.
